(19) United States
(12) Patent Application Publication
(10) Pub. No.: US 2010/0198633 A1
(43) Pub. Date: Aug. 5, 2010

(54) Method and System for Obtaining Social Network Information

(76) Inventors: Ido Guy, Haifa (IL); Michal Jacovi, Haifa (IL); Inbal Ronen, Haifa (IL)

Correspondence Address: IBM CORPORATION, T.J. WATSON RESEARCH CENTER, P.O. BOX 218, YORKTOWN HEIGHTS, NY, 10598, US

(21) Appl. No.: 12/364,524

(22) Filed: Feb. 3, 2009

(51) Int. Cl. G06Q 10/00

(52) U.S. Cl. 705/7

(57) ABSTRACT

A method and system for obtaining social network information are provided. The method includes capturing a social environment at a given time including capturing a set of identities in a predefined proximity to a monitored identity at the given time, wherein an identity is an identity of a real person or a virtual identity, and recording parameters of the social environment. The method then combines the captured social environments in a time range for a monitored identity and analyses the combined captured social environments in the time range to provide a social network for the monitored identity including weightings of the relationships between the monitored identity and the captured identities. The monitored identity and the captured identities may be avatars and the predefined proximity may be a proximity to a virtual location. Alternatively or additionally, the monitored identity and the captured identities may be identities of real people or groups of people, and the predefined proximity may be a proximity to a real location.

### FIELD OF THE INVENTION

This invention relates to the field of social network information. In particular, the invention relates to obtaining social network information from presence locations.

### BACKGROUND OF THE INVENTION

As social networks are becoming more and more popular, there are a lot of systems whose target is to reveal more information about how people are connected and by what means.

The most popular source for weighted social network information is email—the electronic communication is analyzed to show who is related to whom, how strongly, at what periods of times, with respect to which context, and so on. Many other electronic means are also used in an analogous way to obtain social network information, including News Groups, Blogs, Instant Messaging logs, calendar meetings, and so on.

However, some interactions of people can still not be captured by traditional electronic means, as people may meet physically without leaving an electronic trace like an email, a scheduled meeting, a shared document, or so on. Therefore, tapping into the information of people who are in the same physical area can be of value in creating a richer and more complete social network picture.

Moreover, as virtual worlds are becoming popular, an analogous source of such information is also becoming available—that of the presence of a person's virtual identity. Virtual identities in the form of a computer user's representation of himself are referred to as avatars and may be used in Internet forums and other virtual communities or meetings. An avatar's presence information can be used to provide further social network information.

These two sources of presence information in real and virtual worlds can expose useful relationship information.

### SUMMARY OF THE INVENTION

According to a first aspect of the present invention there is provided a method for obtaining social network information executed on a computer hardware system, comprising: capturing a social environment at a given time including: capturing a set of identities in a predefined proximity to a monitored identity at the given time, wherein an identity is an identity of a real person or a virtual identity, and recording parameters of the social environment; combining the captured social environments for the monitored identity in a time range; and analysing the combined captured social environments in the time range to provide a social network for the monitored identity including weightings of the relationships between the monitored identity and the captured identities.

In one embodiment, the monitored identity and the captured identities may be avatars and the predefined proximity may be a proximity to a virtual location. In another embodiment, the monitored identity and the captured identities may be identities of real people or groups of people, and the predefined proximity may be a proximity to a real location.

According to a second aspect of the present invention there is provided a computer software product for obtaining social network information, the product comprising a computer-readable storage medium, storing a computer in which program comprising computer-executable instructions are stored, which instructions, when read executed by a computer, perform the following steps: capturing a social environment at a given time including: capturing a set of identities in a predefined proximity to a monitored identity at the given time, wherein an identity is an identity of a real person or a virtual identity, and recording parameters of the social environment; combining the captured social environments for the monitored identity in a time range; and analysing the combined captured social environments in the time range to provide a social network for the monitored identity including weightings of the relationships between the monitored identity and the captured identities.

According to a third aspect of the present invention there is provided a method of providing a service to a customer over a network, the service executed on a computer hardware system comprising: capturing a social environment at a given time including: capturing a set of identities in a predefined proximity to a monitored identity at the given time, wherein an identity is an identity of a real person or a virtual identity, and recording parameters of the social environment; combining the captured social environments for the monitored identity in a time range; and analysing the combined captured social environments in the time range to provide a social network for the monitored identity including weightings of the relationships between the monitored identity and the captured identities.

According to a fourth aspect of the present invention there is provided a system for obtaining social network information, comprising: a processor; a module for capturing a social environment at a given time including: a module for capturing a set of identities in a predefined proximity to a monitored identity at the given time, wherein an identity is an identity of a real person or a virtual identity, and recording parameters of the social environment; a compiler for combining the captured social environments for the monitored identity in a time range; and an analyser for analysing the combined captured social environments in the time range to provide a social network for the monitored identity including weightings of the relationships between the monitored identity and the captured identities.

### BRIEF DESCRIPTION OF THE DRAWINGS

The subject matter regarded as the invention is particularly pointed out and distinctly claimed in the concluding portion of the specification. The invention, both as to organization and method of operation, together with objects, features, and advantages thereof, may best be understood by reference to the following detailed description when read with the accompanying drawings in which:

FIGS. 1A and 1B are schematic representations of presence information as obtained by the present invention;

FIG. 2 is a block diagram of a system in accordance with the present invention;

FIG. 3 is a block diagram of a computer system in which the present invention may be implemented;

FIG. 4 is a flow diagram of a method in accordance with the present invention;

FIG. 5 is a flow diagram of a method of obtaining real world presence information in accordance with an aspect of the present invention; and

FIG. 6 is a flow diagram of a method of obtaining virtual world presence information in accordance with an aspect of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numbers may be repeated among the figures to indicate corresponding or analogous features.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

A method and system are described for obtaining presence information in order to mine weighted social network information from real and virtual worlds. Identities are captured in the real world or in a virtual world. The term identity is used to refer to any entity including: a person, a group of people, an organisation etc. which has a unique identity. In the real world, the identity is the person or group of people and may be represented by a user ID or name. In virtual worlds, the identity is an avatar or other form of user representation used for meetings in a virtual environment.

For simplicity, mining the information is described in the context of relationships between a monitored person and other people. However, the terms person and people may be substituted for any entity such as a group of people, a company, an organisation, etc. The process can be augmented to create a social network for between entities.

The mining process is different for real world and virtual worlds. For real world, it involves using mobile devices with presence detection (for example, Bluetooth) to get information of identities of other people within close proximity to the person being monitored. For virtual worlds, it involves mining the coordinates of avatars to get information of which avatars are close to the monitored person's avatar. Once the identities' presence information is logged, weighted social networks can be composed according to parameters which have been collected.

In order to obtain the presence information, a social environment is captured at a given moment. The social environment is captured at regular time intervals in a time range. A social environment is defined as the set of people with whom the monitored person is spending his time at a given moment. The method for calculating the social environment is different for real and for virtual worlds and is described in detail below.

Once a technique for capturing the social environment for a monitored person is in place—be it in a real or in a virtual world—the monitored person's weighted social network in a given time period can be calculated. This calculation is based on the log of the monitored person's social environment during that time period.

Specifically, the weight of connection between the monitored person and a person p is determined. In an example embodiment, the weight of connection may use one or more the following parameters based on information captured in the social environments:
1. The number of times person p was part of the monitored person's social environment (each such time will be referred to as an encounter);
2. The duration of each encounter;
3. The number of people in each encounter;
4. The point in time where the encounter took place;
5. The type of location (or “zone”) of the encounter, for example, being next to person p in an ATM line as opposed to sitting next to person p at his home;
6. The distance between the monitored person and person p during the encounter (minimal distance or average distance).

In an example embodiment of a calculation of a weighted social network, the connection weight with person p can be calculated in the following way: summing over all the encounters with person p along the time window, and for each encounter taking the duration of the encounter divided by the number of participants in the encounter. This example takes into account parameters 1, 2, and 3 above.

The fourth parameter can be applied in another example embodiment, by using a decay factor for encounters that took place in the beginning of the time window, or by giving more weight to encounters that took place in a certain time of the day, the week, the month, or the year.

For the fifth parameter, a bonus factor could be given to more personal location types.

The sixth parameter could be considered by normalizing the distance and multiplying the weight by it.

For virtual worlds, further information on an encounter may be exposed which could be considered in the weight computation. For example:
1. A zoom area used during an encounter. A zoom area influences the range a user sees around him and thus the distance to avatars in awareness.
2. Whether or not there was actual interaction between the avatars. For example, did they “talk”, look at each other, use face expressions, perform gestures, etc. or were they just physically close. Actual interaction between avatars should increase the weight between the involved avatars.

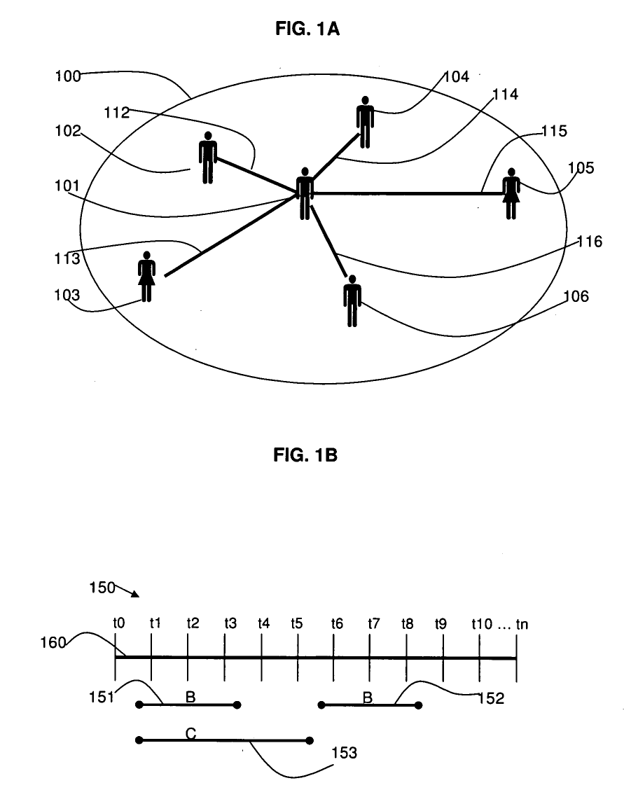

Referring to FIG. 1A, a schematic representation shows a social environment 100 of a monitored person 101. The social environment 100 may be a real world encounter or a virtual world encounter. The social environment 100 includes all other people 102-106 in an encounter with the monitored person 101 at a time t. A distance 112-116 may be measured between each of the people 102-106 in the encounter and the monitored person 101 as one of the social environment parameters. Other parameters may be measured which are not shown as listed above.

Referring to FIG. 1B, a diagram shows a social network 150 for a monitored person A in a time period 160 of t0-tn. At regular predefined times t0, t1, t2, t3, . . . tn a social environment 100 is monitored for the monitored person A. This monitoring captures other people in proximity to person A. In the illustrated example, person B is captured at times t1, t2, t3, and then t7, t8, t9. Person C is captured at times t1, t2, t3, t4, t5. An encounter is defined as the number of times a person is captured in proximity to the monitored person. In this example, person B has two encounters 151, 152 with person A of durations t1-t3 and t6-t8 respectively. Person C has one encounter 153 with person A of duration t1-t5.

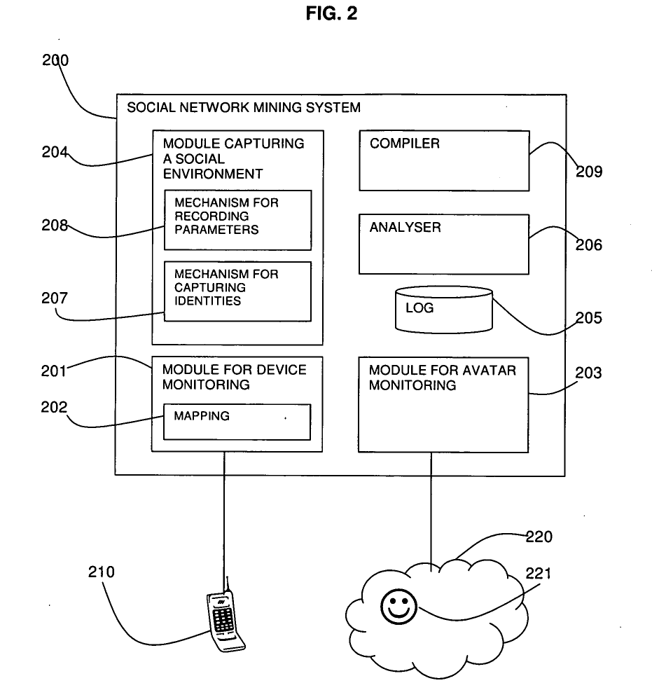

Referring to FIG. 2, a block diagram shows an embodiment of the described social network mining system 200. The social mining system 200 is executed on a computer hardware system.

The social network mining system 200 includes a module for device monitoring 201 which monitors a real person's mobile device 210 such as a Bluetooth device which can provide real world location information. A person's mobile device 210 detects other devices within a location range and this information is monitored by the module for device monitoring 201. The module for device monitoring 201 include a device ID to person ID mapping 202 in order to determine who's device has been detected in proximity to the monitored person's mobile device 210.

The social network mining system 200 may alternatively or additionally include a module for avatar monitoring 203 which monitors a virtual presence 221 in virtual environments 220. The module for avatar monitoring 203 monitors an avatar's interaction with other avatars.

The social network mining system 200 also includes a module for capturing a social environment 204 including a mechanism for capturing identities 207 which uses the monitored information from the module for device monitoring 201 and/or the module for avatar monitoring 203 at a given time to obtain a social environment for a monitored person or avatar at a given time. The module for capturing a social environment 204 includes a mechanism for recording 208 parameters of the social environment. A log 205 of social environment information and parameters as obtained by the module 204 is stored.

A compiler 209 is provided for combining captured social environment information and parameters from the log 205.

An analyzer 206 is provided which analyses the combined information of the compiler 209 of social environment information and includes determining weights of relationships between identities such as people or avatars to provide a weighted social network for a monitored person or avatar. The analyzer 206 may provide a report of a weighted social network.

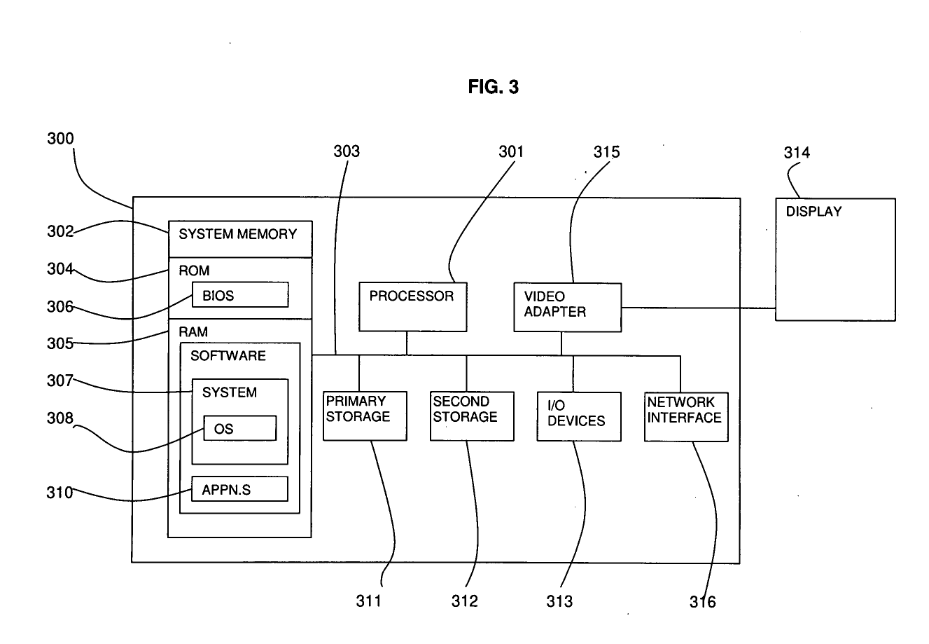

Referring to FIG. 3, an exemplary system for implementing a social network mining system includes a data processing system 300 suitable for storing and/or executing program code including at least one processor 301 coupled directly or indirectly to memory elements through a bus system 303. The memory elements can include local memory employed during actual execution of the program code, bulk storage, and cache memories which provide temporary storage of at least some program code in order to reduce the number of times code must be retrieved from bulk storage during execution.

The memory elements may include system memory 302 in the form of read only memory (ROM) 304 and random access memory (RAM) 305. A basic input/output system (BIOS) 306 may be stored in ROM 304. System software 307 may be stored in RAM 305 including operating system software 308. Software applications 310 may also be stored in RAM 305.

The system 300 may also include a primary storage means 311 such as a magnetic hard disk drive and secondary storage means 312 such as a magnetic disc drive and an optical disc drive. The drives and their associated computer-readable media provide non-volatile storage of computer-executable instructions, data structures, program modules and other data for the system 300. Software applications may be stored on the primary and secondary storage means 311, 312 as well as the system memory 302.

The computing system 300 may operate in a networked environment using logical connections to one or more remote computers via a network adapter 316.

Input/output devices 313 can be coupled to the system either directly or through intervening I/O controllers. A user may enter commands and information into the system 300 through input devices such as a keyboard, pointing device, or other input devices (for example, microphone, joy stick, game pad, satellite dish, scanner, or the like). Output devices may include speakers, printers, etc. A display device 314 is also connected to system bus 303 via an interface, such as video adapter 315.

As stated above, calculating the social environment is done differently for real and virtual worlds.

For real world, devices for obtaining information on a person's location with respect to another person are required. Devices using any wireless communication can be used. For example, Bluetooth devices or WiMax (Worldwide Interoperability for Microwave Access) devices.

In one embodiment, Bluetooth devices can be used limited to a known range (for example, a few meters without a blocking obstacle such as a wall). The social environment at a given time t is calculated based on all individuals whose device IDs are caught by the monitored person's device. This assumes a mapping between device IDs, such as Bluetooth IDs, and people IDs (such as email addresses). Such mapping can be done efficiently within an enterprise where people's IDs are limited and controlled.

Given two devices with Bluetooth support, a score would be added to the corresponding social network based on the time the devices could identify each other. Once signal is not picked up, no scoring addition will be made.

Extension to more devices can be naturally done based on the above. An extension can also include a parameter that would limit Bluetooth to a certain signal power rather than the maximum.

In another embodiment, a system for capturing the social environment in the real world may be implemented based on devices per location (for example, devices in a room in an organization). Sensors can identify entrances and exits of devices from a physical zone, such as a room. The detected entrances and exits from a location can be used to determine the set of individuals attending it at each moment. The social environment at a moment t will be calculated based on the set of individuals attending the same location at t.

Logs of cellular phone locations may also be used. In this case, data will be mined at post mortem and location of people may be crossed to tell who was in proximity at a given time. In the case where presence logs of cellular phones are enabled that indicate the exact location of individuals, social network inference can be done after the event analogously to how they are done in real time using Bluetooth.

For virtual worlds, capturing the social environment is more straightforward as the information is captured from a computer network environment. It requires capturing the coordinates of individual's locations, the obstacles on the links between them. Using the captured information it is determined whether they are likely to be in the same location. In virtual worlds, extensions of the extracted network by context of encounters is more feasible, for examples, by easily capturing the location of the meeting, its content, and so on.

For example, a conference takes place in a virtual world; it is possible to capture the groups of people who are talking to each other during a break, through the channel of communications that are taking place (e.g., chat, voice conversations, etc.). Given that the content of these channels can be captured (trivial with chat, requiring voice transcription with voice), the content of the conversation can be captured and can provide more context to each connection inferred (e.g., if a group of three people discussed “data mining”, it can be added as a context to the relationships between each pair within the three).

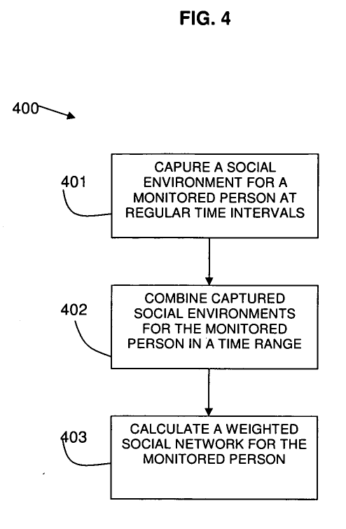

Referring to FIG. 4, a flow diagram 400 shows a general method for obtaining presence information from real and/or virtual worlds. A social environment as defined above is captured 401 for a monitored person at regular time intervals. Captured social environments in a time range are combined 402 for the monitored person. A weighted social network is calculated 403 for the monitored person for the time range by combining and analyzing the information from the social environments. A social network for the monitored person may be provided as a report.

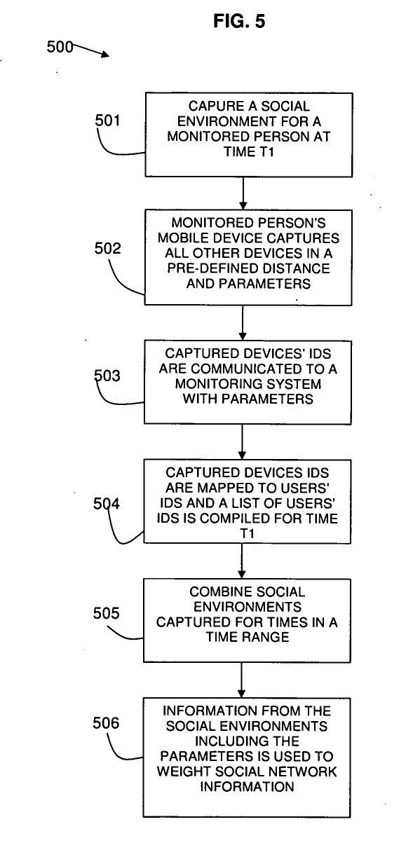

Referring to FIG. 5, a flow diagram 500 shows a method for obtaining presence information from real world encounters.

A social environment is captured 501 at a time, t1. A monitored person's mobile device captures 502 all other devices in a pre-defined distance range at the time t1 together with any parameters of the social environment. The captured devices' IDs are communicated 203 to a monitoring system together with the parameters of the social environment. The captured devices' IDs are mapped 504 to users' IDs and a list of users' IDs is compiled for time t1. Social environments captured for times within a time range are combined 505. The information from the social environments including the parameters is used to weight a social network information for the monitored person.

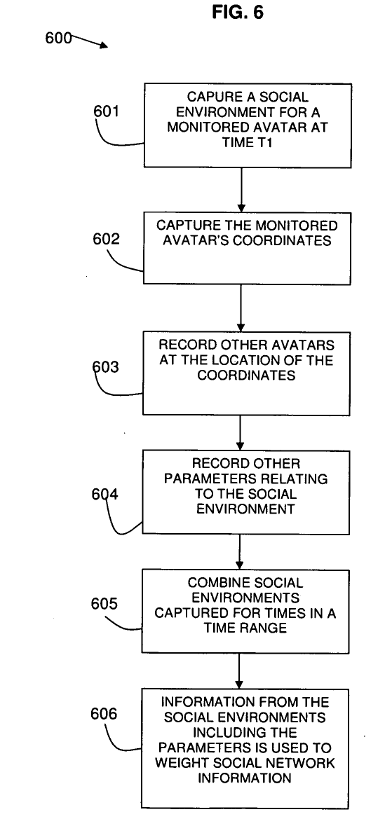

Referring to FIG. 6, a flow diagram 600 shows a method for obtaining presence information from virtual world encounters.

A social environment is captured 601 at a time, t1, by capturing 602 an avatar's coordinates and recording 603 other avatars at the location of the coordinates or in a predetermined proximity to the location. Other parameter relating to the social environment are recorded 604. Social environments captured for times within a time range are combined 605. The information from the social environments including the parameters is used to weight a social network information for the monitored avatar.

A social network weighting based on users' real and/or virtual world encounters may be provided as a service to a customer over a network.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

The invention can take the form of a computer program product accessible from a computer-usable or computer-readable medium providing program code for use by or in connection with a computer or any instruction execution system. For the purposes of this description, a computer usable or computer readable medium can be any apparatus that can contain, store, communicate, propagate, or transport the program for use by or in connection with the instruction execution system, apparatus or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read only memory (ROM), a rigid magnetic disk and an optical disk. Current examples of optical disks include compact disk read only memory (CD-ROM), compact disk read/write (CD-R/W), and DVD.

Improvements and modifications can be made to the foregoing without departing from the scope of the present invention.

1. A method for obtaining social network information executed on a computer hardware system, comprising:
capturing a social environment at a given time including:
capturing a set of identities in a predefined proximity to a monitored identity at the given time, wherein an identity is an identity of a real person or a virtual identity, and
recording parameters of the social environment;
combining the captured social environments for the monitored identity in a time range; and
analysing the combined captured social environments in the time range to provide a social network for the monitored identity including weightings of the relationships between the monitored identity and the captured identities.

2. The method as claimed in claim 1, wherein the monitored identity and the captured identities are avatars and the predefined proximity is a proximity to a virtual location.

3. The method as claimed in claim 1, wherein the monitored identity and the captured identities are identities of real people or groups of people, and the predefined proximity is a proximity to a real location.

4. The method as claimed in claim 1, wherein analysing the combined captured social environments includes determining a number of encounters of an identity p in a social environment with the monitored identity in the time range.

5. The method as claimed in claim 4, wherein analysing the combined captured social environments includes analysing one or more of the group of: a duration of each encounter between an identity p and the monitored identity; a number of people in an encounter; a time range of an encounter; a type of location in an encounter; a distance during an encounter.

6. The method as claimed in claim 2, wherein analysing the combined captured social environments includes analysing one or more of the group of: a zoom area used in a social environment; interactions between avatars.

7. The method as claimed in claim 1, wherein capturing a set of identities in a predefined proximity to a monitored identity at a given time includes:
capturing identities of devices in a predefined proximity to a monitored identity's device; and
mapping captured identities of devices to user's identities.

8. The method as claimed in claim 1, wherein capturing a set of identities in a predefined proximity to a monitored identity at a given time includes:
capturing identities of devices in a known location.

9. The method as claimed in claim 1, wherein capturing a set of identities in a predefined proximity to a monitored identity at a given time includes:
obtaining the coordinates of a monitored identity's avatar and determining other identities' avatars in links within a predefined distance of the monitored identity's avatar.

10. The method as claimed in claim 9, including capturing a context of an online encounter between a monitored identity's avatar and other identities' avatars.

11. A computer software product for obtaining social network information, the product comprising a computer-readable storage medium, storing a computer in which program comprising computer-executable instructions are stored, which instructions, when read executed by a computer, perform the following steps:
capturing a social environment at a given time including:
capturing a set of identities in a predefined proximity to a monitored identity at the given time, wherein an identity is an identity of a real person or a virtual identity, and
recording parameters of the social environment;
combining the captured social environments for the monitored identity in a time range; and
analysing the combined captured social environments in the time range to provide a social network for the monitored identity including weightings of the relationships between the monitored identity and the captured identities.

12. A method of providing a service to a customer over a network, the service executed on a computer hardware system comprising:
capturing a social environment at a given time including:
capturing a set of identities in a predefined proximity to a monitored identity at the given time, wherein an identity is an identity of a real person or a virtual identity, and
recording parameters of the social environment;
combining the captured social environments for the monitored identity in a time range; and
analysing the combined captured social environments in the time range to provide a social network for the monitored identity including weightings of the relationships between the monitored identity and the captured identities.

13. A system for obtaining social network information, comprising:
a processor;
a module for capturing a social environment at a given time including:
a module for capturing a set of identities in a predefined proximity to a monitored identity at the given time, wherein an identity is an identity of a real person or a virtual identity, and
recording parameters of the social environment;
a compiler for combining the captured social environments for the monitored identity in a time range; and
an analyser for analysing the combined captured social environments in the time range to provide a social network for the monitored identity including weightings of the relationships between the monitored identity and the captured identities.

14. The system as claimed in claim 13, wherein the monitored identity and the captured identities are avatars and the predefined proximity is a proximity to a virtual location.

15. The system as claimed in claim 13, wherein the monitored identity and the captured identities are identities of real people or groups of people, and the predefined proximity is a proximity to a real location.

16. The system as claimed in claim 13, wherein the analyser for analysing the combined captured social environments includes a mechanism for determining a number of encounters of an identity p in a social environment with the monitored identity in the time range.

17. The system as claimed in claim 16, wherein the analyser for analysing the combined captured social environments includes a mechanism for using one or more of the group of: a duration of each encounter between an identity p and the monitored identity; a number of people in an encounter; a time range of an encounter; a type of location in an encounter; a distance during an encounter.

18. The system as claimed in claim 14, wherein analysing the combined captured social environments includes a mechanism for using one or more of the group of: a zoom area used in a social environment; interactions between avatars.

19. The system as claimed in claim 13, wherein the module for capturing a set of identities in a predefined proximity to a monitored identity at a given time includes:
a mechanism for determining identities of devices in a predefined proximity to a monitored identity's device; and
a mapping of identities of devices to user's identities.

20. The system as claimed in claim 13, wherein the module for capturing a set of identities in a predefined proximity to a monitored identity at a given time includes:
a mechanism for determining identities of devices in a known location.

21. The system as claimed in claim 13, wherein the module for capturing a set of identities in a predefined proximity to a monitored identity at a given time includes:
a mechanism for obtaining the coordinates of a monitored identity's avatar and determining other identities' avatars in links within a predefined distance of the monitored identity's avatar.

22. The system as claimed in claim 21, including a mechanism for capturing a context of an online encounter between a monitored identity's avatar and other identities' avatars.
